(19) United States
(12) Patent Application Publication
(10) Pub. No.: US 2005/0144285 A1
(43) Pub. Date: Jun. 30, 2005

(54) Finding of tv anytime web services

(76) Inventor: Andrew James Hickman, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/507,196

(22) PCT Filed: Mar. 12, 2003
(86) PCT No.: PCT/IB03/00965

(30) Foreign Application Priority Data
Mar. 14, 2002 (GB) 0205977.2
May 15, 2002 (GB) 0211203.5
Dec. 13, 2002 (GB) 0229248.0

(51) Int. Cl. G06F 15/16

(52) U.S. Cl. 709/227

(57) ABSTRACT

A method for finding TV Anytime web services comprises querying a known address, obtaining a file from the known address, the file having a predefined structure, and parsing the file to obtain URLs for TV Anytime web services. A server system for supplying the file via a network comprises receiving means for receiving the query at the known address, and supplying means for supplying the file in response to the query.

This invention relates to finding TV Anytime web services using a server-based file with a well-known name, location and structure. This invention also relates to a method for aggregating and categorising TV Anytime web services.

The TV Anytime Forum (http://www.tv-anytime.org) is in the process of standardising a set of web services that allow TV Anytime clients (e.g. PDRs—Personal Digital Recorders) to retrieve TV Anytime data (e.g. program schedules, descriptions, etc.) from TV Anytime IP (Internet Protocol) servers. Different types of TV Anytime web services can be offered from a given web site and can have different, unrelated URLs (Uniform Resource Locators).

A number of different methods are possible for discovering web services.

One such method is the use of DNS for finding a TV Anytime service for a particular program identifier. This mechanism is described in the TV Anytime Content Referencing specification (ftp://tva@ftp.bbc.co.uk/pub/Specifications/SP004v11.zip—password “tva”). Given a CRID (Content Reference Identifier), DNS (Domain Name Service) is used to request the machine name and port of a server which is able to provide a TV Anytime service that offers particular information about that CRID. However, once this service has been found it offers no information on the presence or otherwise of other TV Anytime services on the same server. Moreover, not all TV Anytime service types can be found using this deterministic mechanism. For example, if the PDR wishes to find a server that allows the user to search for programmes, then DNS is not helpful.

A second method is the use of UDDI (Universal Description, Discovery and Integration). UDDI (http://www.uddi.org) represents one technology for facilitating the discovery of web services. It relies on the use of third party service repositories that provide a type of web service “Yellow Pages”. By querying the repository a device is able to find web services that match a certain technical description and perhaps match some other taxonomy classification. The approach provides a solution to the problem, “How do I find a list of services that provide a certain service type and are TV Anytime compliant?”.

An alternative possibility is the use of web robots and/or spiders to index a web site. For traditional static web content (i.e. HTML pages) a web robot can be used to find and index the content of a site. The information gained is stored and used for tools such as search engines. However, this is not well suited for direct use by a PDR (it is a slow process, involving multiple network transactions), nor is it particularly useful when the content is dynamically generated by a web service. Although a method could be conceived whereby a TV Anytime search engine blindly tries to discover services by testing their behaviour, this would be prohibitively slow, error prone and not guaranteed to find all the TV Anytime services provided by that site.

Also relevant is the use of a robots.txt file, described at http://www.robotstxt.org/wc/robots.html. By placing a robots.txt file in a well-known place on a server (e.g. http://foo.com/robots.txt) a server is able to specify a set of rules for the whole web site, which compliant web robots will obey. Whilst not directly relevant to TV Anytime, this is an example of the use of placing a file (with well-known name, structure and location) on a web server to provide information about the web site that can be used both automatically and manually.

The object of this invention is to allow a PDR to automatically find out whether an arbitrary web site offers TV Anytime services, and if so which types of services it offers.

According to a first aspect of the present invention, there is provided a method for finding TV Anytime web services comprising querying a known address, obtaining a file from said address, said file having a predefined structure, and parsing said file to obtain URLs for TV Anytime web service description files.

According to a second aspect of the present invention, there is provided apparatus for finding TV Anytime web services comprising communicating means for querying via a network a known address and for obtaining a file from said address, said file having a predefined structure, and processing means for parsing said file to obtain URLs for TV Anytime web service description files.

According to a third aspect of the present invention, there is provided a method for providing access to TV Anytime web services comprising receiving a query at a known address, and supplying a file in response to said query, said file including URLs to TV Anytime web service description files.

According to a fourth aspect of the present invention, there is provided a server system for providing access to TV Anytime web services comprising receiving means for receiving a query at a known address, and supplying means for supplying a file in response to said query, said file including URLs to TV Anytime web service description files.

According to a fifth aspect of the present invention, there is provided a method of spidering websites comprising recursively addressing a URL for a non-HTML web service description file, parsing said file to obtain further URLs for non-HTML web service description files, and recording said further URLs.

According to a sixth aspect of the present invention, there is provided a server system for supplying URLs for TV Anytime web services via a network comprising receiving means for receiving a query, supplying means for supplying one or more URLs for TV Anytime web services in response to said query, and storing means for storing a categorised list of TV Anytime web services.

This invention provides a solution to the problem, “How do I know if this web-site offers any TV Anytime services, and if it does where are they?” A solution is needed for two reasons. Firstly, a PDR may be aware of a particular web site (i.e, machine name and port number) as a result of any number of processes (see below). It would be useful if the PDR can automatically find whether TV Anytime web services are available. Having established this, the PDR should be able to deduce the types of services offered and where they are offered. Secondly, there is likely to be a market for third party sites that categorise and index the available TV Anytime services (the TV Anytime equivalent of a web directory or search engine). By providing a standardised description mechanism a web tool is able to automatically discover and categorise TV Anytime services without the need for human intervention.

Once the PDR has established the existence of TV Anytime services it needs to find out the following information about each of those services: the to location where that service is being offered, the type of TV Anytime service being offered, the technical compliance of that service, and the version number of that TV Anytime service.

The mechanism proposed is to place a file on the server, which has a standardised structure containing the necessary information. This file has a well-known name and is placed at the entry point to the website, thus allowing a PDR to retrieve the file automatically. The invention specifically includes the use of the WS-Inspection standard to define the file structure and name of the file (inspection.wsil).

If a web site does offer TV Anytime services it places a file with a well-known name at the entry point to that web site. To obtain the file the PDR makes an HTTP GET request to the following URL. http://<machine name>:<port number>|<well known file name> The port number is optional and typically would not be included. The exception is DNS, where the DNS mechanism will explicitly return a port number as well as a machine name. A machine-readable document (this could be XML but does not have to be) is returned which indicates the presence of TV Anytime services by containing references (URLs) to one or more service description files. This invention does not mandate the type of service description file that should be used, but specifically includes the use of WSDL (Web Services Description Language) and UDDI to provide the four pieces of information listed in section 2. Each service description file may, in turn, provide information on more than one TV Anytime service depending on how the web site chooses to group their web services. The document may also give the URLs of other related TV Anytime server files to facilitate the discovery and linking together of new services. The mechanism has the following advantages: that it is lightweight and easy for a web site to implement, it allows a new TV Anytime web server to describe itself without having to register with a third party, and it facilitates discovery and indexing mechanisms for use by a web robot in the process of generating a database for a TV Anytime services search engine.

The invention assumes that the PDR already has knowledge of a particular web site. The domain name could have been obtained by a number of different mechanisms. For example, the user has heard of a TV Anytime service through some other medium (e.g. recommendation or advertising) and manually enters the domain name into their PDR. Alternatively, the PDR might support a web browser to allow the user to web surf. It would be relatively inexpensive for a PDR to attempt to download the TV Anytime file (if any) of the web sites visited by the user. Equally, the DNS mechanism described above could be used. A PDR might receive CRIDs from a number of different sources (e.g. embedded in the video stream, as a result of searches, as a result of a program recommendation, or as a result of a remotely generated request to record a program). The authority name can be extracted from CRIDs and used as the domain name in an attempt to find a TV Anytime server file.

In addition, a business model is proposed, whereby third parties can offer search and categorisation services specifically for TV Anytime web servers. This can be viewed as analogous to the search and directory engines (such as Google, Yahoo, etc.) used to discover HTML based web sites. To create such a website, a method for how the third party can automatically aggregate this information is described. A specific use of WS-Inspection specification is proposed that allows third parties to spider between TV Anytime web servers in an efficient fashion.

Embodiments of the invention will now be described, by way of example only, with reference to the accompanying drawings, in which:—

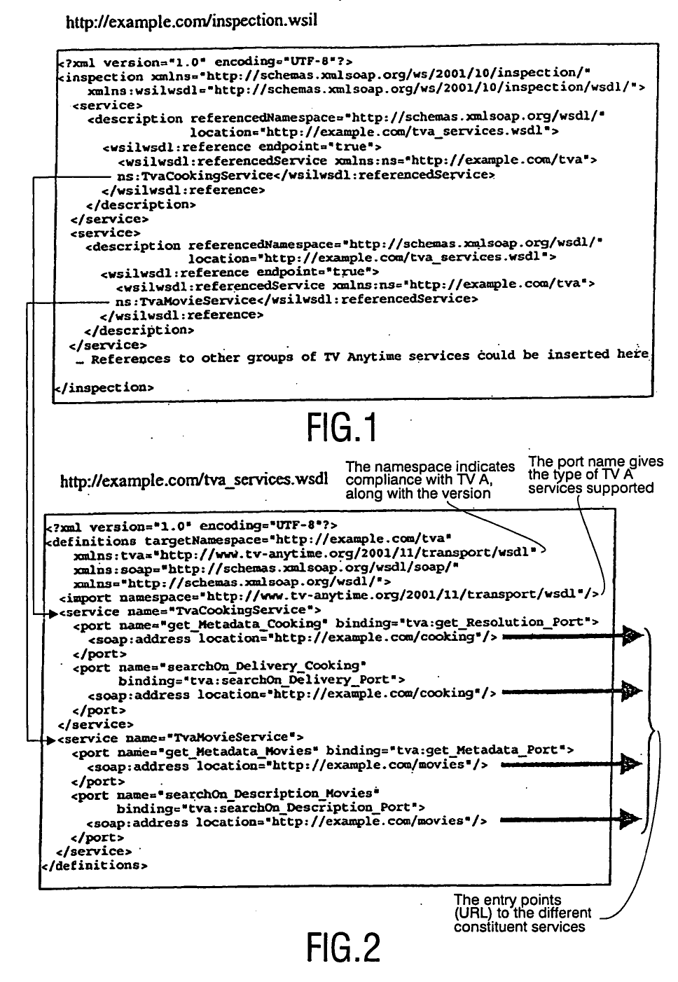

FIG. 1 is an example of a possible WS-Inspection file,

FIG. 2 is an example of a corresponding service description file,

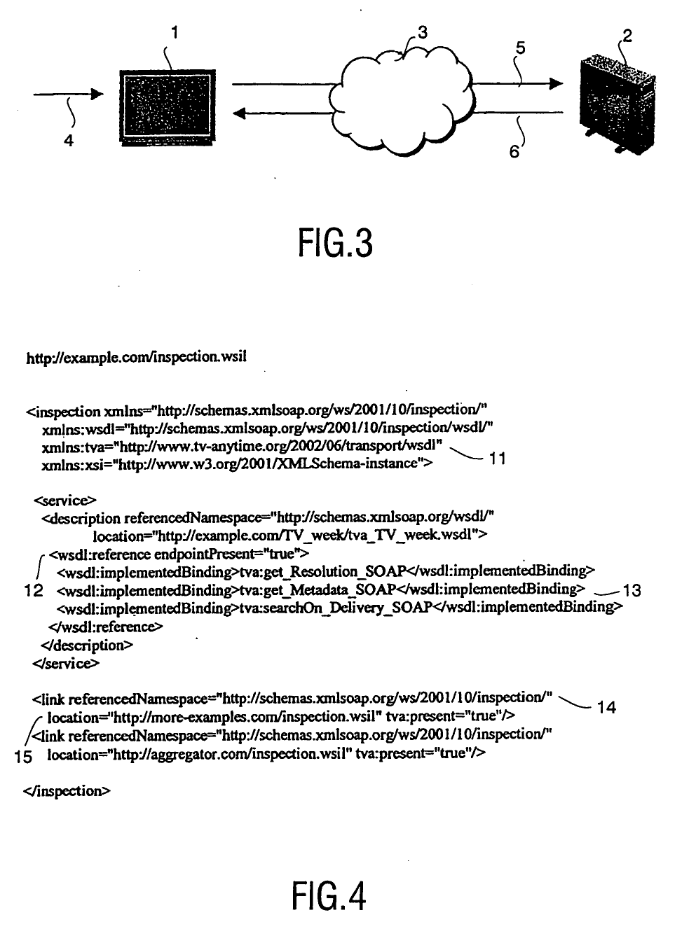

FIG. 3 is a schematic diagram of apparatus for finding TV Anytime web services, illustrating a device and a server,

FIG. 4 shows a second embodiment with an improved WS-Inspection file,

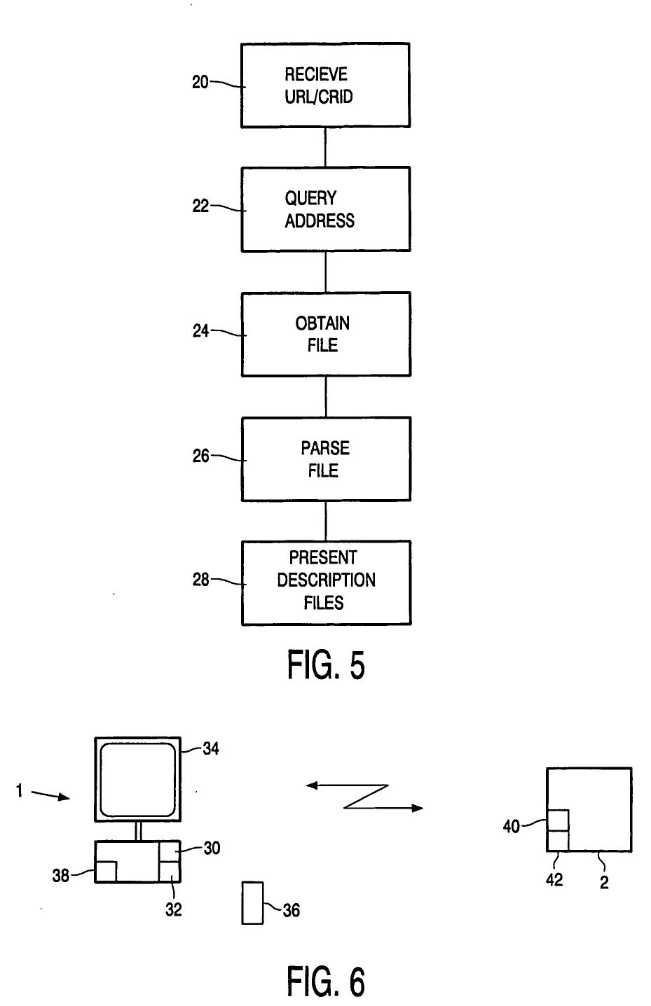

FIG. 5 is a schematic diagram of a method of finding TV Anytime web services, and

FIG. 6 is a schematic diagram of the device and server system of FIG. 3, showing further detail.

The invention applies to TV Anytime IP clients and servers. A client is any device that wishes to receive information related to TV programme schedules could use this invention. Typically this will be a Personal Digital Recorder or some other TV device (Integrated Digital TV, set-top-box, etc.) that wishes to display TV schedules to a user. However, any other network-enabled devices could also exploit the invention for the same purpose. These include Personal Computers, mobile phones, PDAs, etc. A server is any web server with the appropriate information can host a TV Anytime service. Most often this will be a broadcaster's web server, but also includes third party web sites providing specialised and enhanced metadata about TV programmes.

FIG. 3 shows a network enabled TV Anytime device, for example, an integrated digital television 1, which is connected via a wide area network (such as the Internet) 3, to a remote network web server 2. The server 2 is possibly offering one or more TV Anytime compliant web services, for example schedule listings or movie information etc. In broad terms, as illustrated in FIG. 5, the device 1 finds TV Anytime web services by receiving a web server host name 4, sending a structured query 5 to the server 2 and receiving a structured response 6 back from the server 2. The query and response can be in any standard form such as HTTP or SOAP.

More specifically, the steps involved in finding new TV Anytime services, require the following sequence of requests 5 and responses 6. Firstly, the device 1 obtains a host name 4, such as example.com (method step 20). Two possible routes for the generation of the host name 4 include simply receiving a basic URL to use as the host name 4 directly from a user interface on the device 1, or receiving a CRID (which may be broadcast to the device 1 as part of a broadcast stream) and generating a basic URL for use as the host name 4 from the CRID.

The device 1 then makes an HTTP GET request, querying 22 a known address, to the server 2 for the well-known file (e.g. http://example.com/inspection.wsil). The known address is generated by taking the basic URL (host name 4) and adding to it a predefined suffix. If the server 2 offers web services (not necessarily TV Anytime ones) it will return a successful HTTP response containing the requested file (inspection.wsil), a possible format of such a file being illustrated in FIG. 1. If the server 2 offers no web services it will send back an HTTP 404 (file not found) response and the search process will terminate.

Following obtaining of the file (method step 24), device 1 parses 26 the file and establishes the endpoints of the service descriptions (such as the URL of a WSDL file describing how to use the services). All of the subsequent steps will be repeated for each of the end points found. Device 1 then tries to obtain the service description for that endpoint. The exact mechanism for doing this depends on the service description protocol being used (such as UDDI or WSDL). In this example, WSDL is being used. To obtain the WSDL file, device 1 makes an HTTP GET request to the server 2 for the file (e.g. http://example.com/tva_services.wsdl), an example of which is shown in FIG. 2.

Device 1 parses the returned file and establishes if any of the described services are TV Anytime compliant services. This is determined by the XML namespace given to the services. If none of the endpoints offer TV Anytime services the search process will terminate. The file also allows device 1 to determine the precise technical version of each service as well as the URL where the service is offered. Device 1 now has all the information required to use the TV Anytime web service. At this stage device 1 may choose to cache the information on the TV Anytime services offered by that server, or to make use of those services immediately. The device 1 also has the option to present the human readable portion of the service descriptions to a user (method step 28) the user selecting one of the service descriptions and the device 1 obtaining a TV Anytime web service from the user selected URL.

The device 1 illustrated in FIG. 6 comprises communicating means 30 for querying via a network a known address and for obtaining a file from the address, the file having a predefined structure, and processing means 32 for parsing the file to obtain URLs for TV Anytime web service description files. The device further comprises a display device 34 for displaying the human readable portion of the service description, and user interface means 36 (a suitable remote control) for inputting a URL. Also provide is storage means 38 for storing the TV Anytime web service obtained by the communicating means 30.

The server system 2 of FIG. 6 comprises receiving means 40 for receiving a query at a known address, and supplying means 42 for supplying a file in response to the query, the file having a predetermined structure.

Some additional restrictions regarding the way the description part of the structured file is formatted can be used to facilitate the process. This is illustrated in FIG. 4. Specifically, when describing a TV Anytime web service, the structured file should include the following information in its descriptions of the web services available at that site: an indication that the service is a TV Anytime service, the protocol version of the TV Anytime service, and the types of TV Anytime services offered. This information must be present in the structured file itself and not by means of reference (e.g. a reference to a detailed description of that service). In this way, there is no need to download and parse other files in order to establish the existence of a TV Anytime service. Consequently, the amount of processing required at each node of the search space is also reduced, once again enabling more effective spidering of TV Anytime web services.

The Web Services Inspection Language provides one standard method of specifying how to inspect a web site for available Web services. The WS-Inspection specification defines the locations on a Web site where you could look for Web service descriptions. The following URLs give an overview and the specification of WS-Inspection:
http://www-106.ibm.com/developerworks/webservices/library/ws-wsilover/
http://www-106.ibm.com/developerworks/webservices/library/ws-wsilspec.html

FIG. 4 shows a second embodiment with an improved WS-Inspection file. This file structure has two advantages over the WS-Inspection file of FIG. 1. Firstly a client device can establish directly from the file the existence of TV Anytime compliant web services without the need for further network transactions. Secondly the links to other TV Anytime WS-Inspection files enable spidering of TV Anytime web services.

Illustrated in this Figure is the TV Anytime namespace 11, which indicates the version of the protocol being referenced, the endpointPresent attribute 12, which indicates that the TV Anytime service is actually available and an implementedBinding element 13 qualified by the namespace prefix (“tva:”), to indicate the types of TV Anytime services available. These items 11, 12 and 13 indicate how to use the WS-Inspection description elements to reference TV Anytime services. The use of implementedBinding elements means that any spidering robots do not need to download a WSDL file (as given in the location attribute) to establish the presence of TV Anytime service.

Item 14 is a link indicating the presence of a URL offering a structured file of the same format as this one and item 15 is the present attribute, indicating that at least one TV Anytime service is referenced in the document that is being linked to. Items 14 and 15 indicate how links to other WS-Inspection documents are shown. By following these links other WS-Inspection documents containing references to TV Anytime services will be found.

Although the foregoing provides a means by which a web site can identify whether it has TV Anytime services (and if so where they are), this is only useful if the client has prior knowledge of the existence of that web site. In order to find specific TV Anytime services, the only means available to a client device is to conduct an exhaustive search (spidering) of all web sites and to use the mechanism described above to test each one for the existence of TV Anytime services. Such a process is computationally expensive and certainly not feasible for the types of clients envisaged (digital TV receivers, PDAs, etc.).

Therefore it is necessary to alter the searching process to relieve the computational burden placed on the client device. This can be achieved by the use of a third party web site containing categorised web services. Since the vast majority of web sites will not offer TV Anytime web services, the searching process is altered to enable spidering of the web in a way that efficiently discovers TV Anytime web servers.

It is proposed that a third party is responsible for conducting the spidering process. There are no restrictions on who this third party might be. Some examples are: a broadcaster wishing to offer a value-adding service for TV Anytime clients; a CE manufacturer wishing to improve the functionality of the equipment they manufacture; and a specialist interest web site wishing to provide TV Anytime information to its users. Since a powerful computer can do the spidering the computational expense is less problematic. The third party maintains a directory of all the TV Anytime web services it has found. This directory might offer an HTML interface to allow users to find and browse the discovered TV Anytime services. The directory can add value by categorising and grouping the services in certain ways that help the user find the services they want.

In order for the consuming client (i.e. TV Anytime device, such as a digital TV receiver) to be able to automatically retrieve the information from the machine hosting the third party directory, a standard means of describing the list of discovered services is necessary. Such a description could be agreed by some standards body (such as the TV Anytime Forum). Alternatively, if the directory service is hosted by a CE manufacturer, they may choose to implement a private description format since they control both the client implementation (i.e. the CE device) and the directory server.

Another way this invention could be exploited would be for the directory service to offer a single integrated TV Anytime web service, giving access to all the data available from the services that have been discovered. It could then offer the aggregated data through a single TV Anytime web service.

The efficient spidering of TV Anytime services is based upon the mechanism described above of using a structured file (in a well-known location) to describe the TV Anytime services available from that server. Here, it is additionally proposed that this structured file is allowed to contain URLs (i.e. hyperlinks) to the description files on other TV Anytime web servers. In this way, a “web service spider” can be used to recursively find and download the structured file for many TV Anytime web sites.

By spidering across standardised service location files, rather than HTML files, the search space is vastly reduced and the process made more efficient. The structured file is split into two sections—links and descriptions—both of which are optional. A structured file that contains only links can be used to represent a list of TV Anytime web services. This format can itself be used by the directory service as a means of describing all the services it has found.

1. A method for finding TV Anytime web services comprising querying a known address, obtaining a file from said address, said file having a predefined structure, and parsing said file to obtain URLs for TV Anytime web service description files.

2. A method according to claim 1, and further comprising receiving a CRID and generating a basic URL from said CRID.

3. A method according to claim 1, and further comprising receiving a basic URL.

4. A method according to claim 2 or 3, wherein said known address is generated by taking said basic URL and adding to it a predefined suffix.

5. A method according to any preceding claim, and further comprising presenting a human readable portion of said web service description files to a user, said user selecting a TV Anytime web service and obtaining said TV Anytime web service.

6. Apparatus for finding TV Anytime web services comprising communicating means for querying via a network a known address and for obtaining a file from said address, said file having a predefined structure, and processing means for parsing said file to obtain URLs for TV Anytime web service description files.

7. Apparatus according to claim 6, and further comprising a display device for displaying a human readable potion of said web service description files.

8. Apparatus according to claim 6 or 7, and further comprising user interface means for inputting a URL.

9. Apparatus according to claim 7, wherein a user selects a TV Anytime web service and said communicating means obtains said TV Anytime web service.

10. Apparatus according to claim 9, and further comprising storage means for storing the TV Anytime web service obtained by the communicating means.

11. A method for providing access to TV Anytime web services comprising receiving a query at a known address, and supplying a file in response to said query, said file including URLs to TV Anytime web service description files.

12. A method according to claim 11, wherein said known address is generated by placing said file at the entry point of a web site.

13. A method according to claim 11 or 12, wherein said file further contains information on each web service for each respective URL.

14. A server system for providing access to TV Anytime web services comprising receiving means for receiving a query at a known address, and supplying means for supplying a file in response to said query, said file including URLs to TV Anytime web service description files.

15. A system according to claim 14, wherein said known address is generated by placing said file at the entry point of a web site.

16. A system according to claim 14 or 15, wherein said file further contains information on each web service for each respective URL.

17. A method of spidering websites comprising recursively addressing a URL for a non-HTML web service description file, parsing said file to obtain further URLs for non-HTML web service description files, and recording said further URLs.

18. A server system for supplying URLs for TV Anytime web services via a network comprising receiving means for receiving a query, supplying means for supplying one or more URLs for TV Anytime web services in response to said query, and storing means for storing a categorised list of TV Anytime web services.
